(19) United States
(12) Patent Application Publication
(10) Pub. No.: US 2011/0277616 A1
(43) Pub. Date: Nov. 17, 2011

(54) LOW FREQUENCY MASSAGE APPARATUS OPERATING IN CONJUCTION WITH MUSIC AND METHOD OF OPERATING THE SAME

(75) Inventor: Jeong Hoon PARK, Seoul (KR)

(73) Assignee: MIRAE MEDICAL CO., LTD., Seoul (KR)

(21) Appl. No.: 13/102,789

(22) Filed: May 6, 2011

(30) Foreign Application Priority Data
May 11, 2010 (KR) 10-2010-0044096
Nov. 17, 2010 (KR) 10-2010-0114594

(51) Int. Cl. G10H 1/40

(52) U.S. Cl. 84/611

(57) ABSTRACT

A low frequency massage apparatus may include a wired sound source input module for receiving a sound source signal being played, a frequency filter module for classifying the sound source signal according to frequencies, an A/D converter module for digitally converting the classified sound source signal, a music classification module for classifying the converted sound source signal for each musical instrument or for each genre, a database for storing pieces of frequency information for each musical instrument, pieces of frequency information for each genre, and pieces of massage pattern information, a massage pattern change module for loading a massage pattern, corresponding to the sound source signal, from the database and changing the massage pattern according to frequency components of the sound source signal, and an output channel change module for setting the changed massage pattern for each output channel and outputting the set massage pattern to the output terminals of massage pads.

### CROSS-REFERENCE TO RELATED APPLICATION

Priority to Korean patent application numbers 10-2010-0044096 and 10-2010-0114594, filed on May 11, 2010, and Nov. 17, 2010, respectively, is claimed. The entire disclosure of each application is incorporated by reference herein.

### BACKGROUND OF THE INVENTION

1. Field of the Invention

The present invention relates to a low frequency massage apparatus operating in conjunction with music and a method of operating the same and, more particularly, to a low frequency massage apparatus operating in conjunction with music, which is capable of controlling output according to the kind of a musical instrument and the genre of a song by operating the output part of the massage apparatus in conjunction with music, and a method of operating the same.

2. Background of the Related Art

The moderns who are troubled with various stresses and works are having a massage owing to the effects of the massage which relieve the fatigue of the body and give metal ease to people. It would be better to have such a massage through a massagist, but many people purchase artificial massage machines because of economic circumstances and a temporal reason. Massage machines equipped with various functions and characteristics are installed in sauna rooms and homes and are being frequently used by people.

In general, apparatuses having a massage function and being developed to improve health, such as thermal massage machines and low frequency massage machines, are on the market.

The thermal massage machines are classified into products using massage balls and products not using massage balls. The thermal massage machine includes heating wires installed within a pad (that is, a panel of a bed form so that a person can lie down in the bed) and a pad installed on the heating wires and treats various parts of the body.

The low frequency massage machine massages muscles through stimuli by applying fine electromagnetic waves of 30 to 300 kHz to a human body. The low frequency massage machine is a physical therapy machine using electropathy, having + or − electrode for the contraction and relaxation of muscles and having current flow therethrough. Accordingly, the low frequency massage machine has an effect of a concentrated exercise machine for each part of the body because the amount of heat is consumed by muscles and the consumption of a calorie is increased owing to a temperature rise within the skin. Furthermore, the low frequency massage machine is being used in hospitals and sports centers because of pain relief, rehabilitation, the improvement of the circulation of the blood, and an increase of muscular strength and is configured to recover the bio rhythm of the body through various forms, such as tap, fingering, and press.

However, the massage machine having all the above massage functions is chiefly configured to control the driving speed of a motor in order to adjust the strength and weakness of a massage, and the driving speed of the motor is fixed when the massage machine is delivered from a factory. The movement of a massage is not changed according to rhythm, but the speed of a massage is determined by a standardized pattern, such as a high speed, a middle speed, or a low speed. Accordingly, the conventional massage machine gives a tedious feeling because of the repeated function of the simple pattern and does not provide consistent and periodic treatment when periodic treatment and massages are required. Consequently, a person who continuously uses the conventional massage machine frequently feels reluctant to use the massage machine. Furthermore, the conventional massage machine is disadvantageous in that the effects of a massage are very limited.

### SUMMARY OF THE INVENTION

Accordingly, the present invention has been made in view of the above problems occurring in the prior art, and it is an object of the present invention to provide a low frequency massage apparatus operating in conjunction with music, wherein inputted music and the low frequency massage apparatus are operated in conjunction with each other, thereby giving a person a feeling of being massaged by a massagist according to music through harmony.

It is an object of the present invention to provide a method of operating the low frequency massage apparatus operating in conjunction with music, wherein a pattern of a massage is applied to an output terminal by detecting a musical instrument characteristic corresponding to rhythm, a musical instrument characteristic corresponding to a melody, and a shift of the entire music level in order to maximize the effects of a massage.

To achieve the above objects, a low frequency massage apparatus operating in conjunction with music according to the present invention includes a wired sound source input module for receiving a sound source signal being played, a frequency filter module for classifying the inputted sound source signal according to frequencies, an A/D converter module for digitally converting the sound source signal classified by the frequency filter module, a music classification module for classifying the converted sound source signal for each musical instrument or for each genre, a database for storing pieces of frequency information for each musical instrument, pieces of frequency information for each genre, and pieces of massage pattern information, a massage pattern change module for loading a massage pattern, corresponding to the sound source signal classified by the music classification module, from the database and changing the massage pattern according to frequency components of the sound source signal, and an output channel change module for setting the massage pattern, changed by the massage pattern change module, for each output channel and outputting the set massage pattern to the output terminals of massage pads.

The output channel change module preferably classifies and sets the output channels according to rhythm of the sound source signal and a height of a tone and outputs the massage pattern to the output terminals of the different massage pads according to the rhythm of the sound source signal and the height of the tone.

The low frequency massage apparatus further includes a frequency tuning module for tuning the frequency of the sound source signal according to a height of a preset tone in order to solve tracking occurring when an area of the sound source signal is different.

The music classification module preferably includes a load unit for loading a value of frequency components corresponding to the frequency information for each musical instrument or the frequency information for each genre, a frequency comparison unit for comparing the value of the frequency components, loaded by the load unit, and a value of the frequency components of the sound source signal, and an attribute determination unit for classifying rhythm and a genre of the sound source based on the value obtained by the frequency comparison unit.

Furthermore, the massage pattern change module includes a pattern load unit for loading a massage pattern of a relevant genre from the database based on a genre of the sound source signal classified by the music classification module and a pattern change unit for changing the loaded massage pattern of the genre based on a value of the frequency components of the sound source signal.

Furthermore, the output channel change module includes a rhythm check unit for changing rhythm of each of the channels from which the massage pattern changed by the massage pattern change module is outputted, a strength and weakness check unit for changing a strength and weakness of each channel from which the massage pattern changed by the massage pattern change module is outputted, and a multiplexer for sending a changed signal to each channel from which the massage pattern changed by the rhythm check unit and the strength and weakness check unit is outputted.

To achieve the above objects, a low frequency massage apparatus operating in conjunction with music according to the present invention includes a wireless communication module for receiving a sound source signal, being played, from sound source play means through wireless transmission in order to facilitate connection to the sound source play means, a frequency filter module for classifying the inputted sound source signal according to frequencies, an A/D converter module for digitally converting the sound source signal classified by the frequency filter module, a music classification module for classifying the converted sound source signal for each musical instrument or for each genre, a database for storing pieces of frequency information for each musical instrument, pieces of frequency information for each genre, and pieces of massage pattern information, a massage pattern change module for loading a massage pattern, corresponding to the sound source signal classified by the music classification module, from the database and changing the massage pattern according to frequency components of the sound source signal, and an output channel change module for setting the massage pattern, changed by the massage pattern change module, for each output channel and outputting the set massage pattern to the output terminals of massage pads.

The output channel change module preferably classifies and sets the output channels according to rhythm of the sound source signal and a height of a tone and outputs the massage pattern to the output terminals of the different massage pads according to the rhythm of the sound source signal and the height of the tone.

The low frequency massage apparatus further includes a frequency tuning module for tuning the frequency of the sound source signal according to a height of a preset tone in order to solve tracking occurring when an area of the sound source signal is different.

The music classification module preferably includes a load unit for loading a value of frequency components corresponding to the frequency information for each musical instrument or the frequency information for each genre, a frequency comparison unit for comparing the value of the frequency components, loaded by the load unit, and a value of the frequency components of the sound source signal, and an attribute determination unit for classifying rhythm and a genre of the sound source based on the value obtained by the frequency comparison unit.

Furthermore, the massage pattern change module includes a pattern load unit for loading a massage pattern of a relevant genre from the database based on a genre of the sound source signal classified by the music classification module and a pattern change unit for changing the loaded massage pattern of the genre based on a value of the frequency components of the sound source signal.

Furthermore, the output channel change module includes a rhythm check unit for changing rhythm of each of the channels from which the massage pattern changed by the massage pattern change module is outputted, a strength and weakness check unit for changing a strength and weakness of each channel from which the massage pattern changed by the massage pattern change module is outputted, and a multiplexer for sending a changed signal to each channel from which the massage pattern changed by the rhythm check unit and the strength and weakness check unit is outputted.

To achieve the above objects, a low frequency massage method operating in conjunction with music includes the steps of playing a sound source signal in the massage apparatus, inputting the played sound source signal, converting the inputted sound source signal into a digital signal through a frequency filter, classifying the sound source signal, converted into the digital signal, for each rhythm and for each genre, changing a massage pattern according to an input signal of the classified sound source signal based on a pattern stored in a database, and changing the changed massage pattern for each pad and outputting the changed massage pattern.

### BRIEF DESCRIPTION OF THE DRAWINGS

Further objects and advantages of the invention can be more fully understood from the following detailed description taken in conjunction with the accompanying drawings in which:

FIG. 1 is a block diagram showing the entire construction of a low frequency massage apparatus operating in conjunction with music according to the present invention;

FIG. 2 is a detailed block diagram of a music classification module according to the present invention;

FIG. 3 is a detailed block diagram of a pattern change module according to the present invention;

FIG. 4 is a detailed block diagram of an output channel change module according to the present invention;

FIG. 5 is a flowchart illustrating a massage method operating in conjunction with music according to the present invention; and

FIG. 6 is a flowchart illustrating an embodiment in which the low frequency massage apparatus operating in conjunction with music according to the present invention is used.

<Description of reference numerals of principal elements in
the drawings>

| | |
|---|---|
| 110: input module | 120: frequency filter module |
| 130: A/D converter | 140: database |
| 150: music classification module | 151: load unit |
| 152: frequency comparison unit | |
| 153: attribute determination unit | |
| 160: pattern change module | 161: pattern load unit |
| 170: output channel change module | |
| 162: pattern change unit | 171: rhythm check unit |
| 172: strength and weakness check unit | |
| 173: multiplexer | 180: massage pad |

### DETAILED DESCRIPTION OF EMBODIMENTS

Some embodiments of the present invention will now be described in detail with reference to the accompanying drawings, but the embodiments are described in detail to the extent that those skilled in the art to which the present invention pertains can readily implement the embodiments. Accordingly, the technical spirit and category of the present invention are not limited to the embodiments.

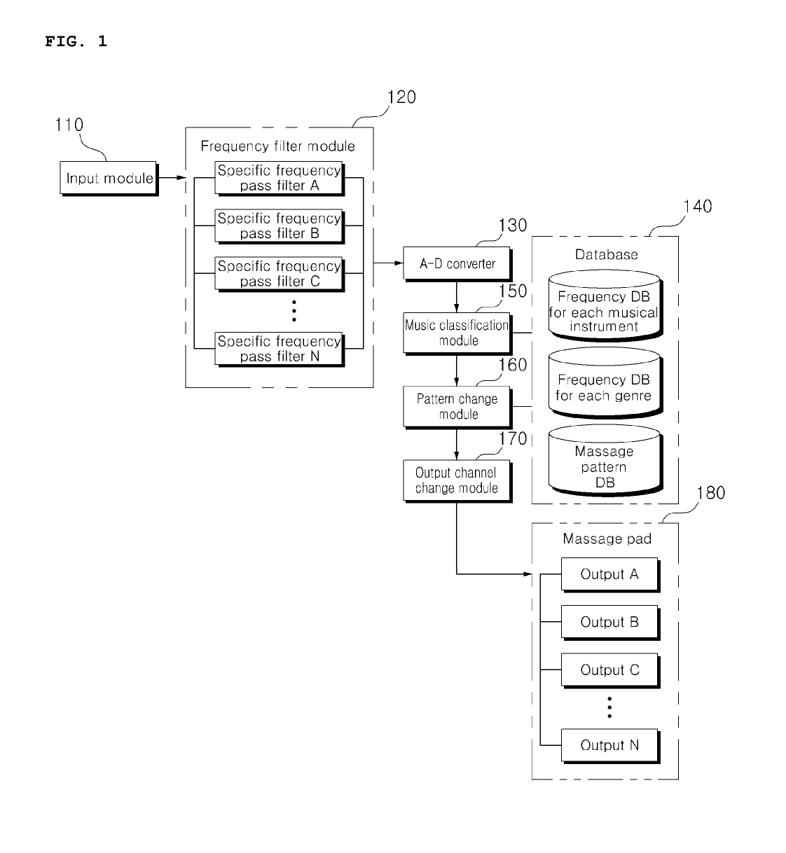

FIG. 1 is a block diagram showing the entire construction of a low frequency massage apparatus operating in conjunction with music according to the present invention.

As shown in FIG. 1, the low frequency massage apparatus operating in conjunction with music includes an input module 110 for receiving a sound source, a frequency filter module 120 for separating signals for each frequency by transmitting all frequencies or only a specific frequency, an analog/digital (A/D) converter 130 for converting an inputted analog signal into a digital signal, a database 140 for storing pieces of frequency information for each musical instrument, pieces of frequency information for each genre, and pieces of massage pattern information, and a massage pad 180 for performing a massage along with a music classification module 150 for classifying a genre and rhythm based on the frequency of an inputted sound source signal, a pattern change module 160 for changing a massage pattern outputted according to rhythm and a genre classified by the music classification module 150, and an output channel change module 170 for sending an output pattern, changed by the pattern change module 160, to each pad in various ways.

The low frequency massage apparatus further includes a wireless communication module for sending the sound source signal, now being played, to the frequency filter module 120 wirelessly in order to facilitate connection to sound source play means (e.g., an MP3 player).

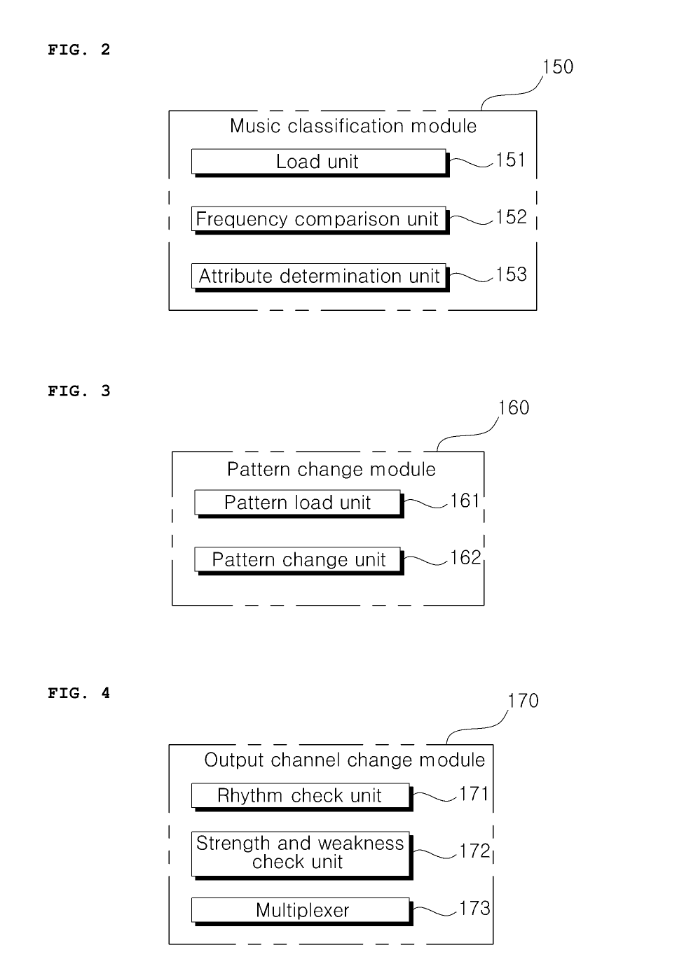

FIG. 2 is a detailed block diagram of the music classification module 150 according to the present invention.

As shown in FIG. 2, the music classification module 150 functions to classify rhythm and a genre on the basis of the inputted sound source signal classified for each frequency through the frequency filter module 120. To this end, a load unit 151 loads a frequency for each genre and a frequency for each musical instrument which are stored in the database 140. Furthermore, a frequency comparison unit 152 performs a comparison task of the inputted sound source signal, classified for each frequency, for each musical instrument and for each genre, on the basis of the pieces of frequency information for each musical instrument and the pieces of frequency information for each genre. An attribute determination unit 153 functions to determine a massage pattern, having the most similar attribute to the inputted sound source signal, in the database 140 based on a value obtained by the frequency comparison unit 152. For example, when the inputted sound source signal is heavy metal music, rock music having the most similar genre to heavy metal music, from among classical music, pop music, Latin music, and rock music may be determined. A musical instrument used in the sound source may be classified for each musical instrument, such as vocal, a drum, a base, or an electric guitar, and rhythm can be recognized as a drum frequency having the most regular beat.

FIG. 3 is a detailed block diagram of the pattern change module 160 according to the present invention.

The pattern change module 160 changes a massage pattern according to the sound source signal classified based on the massage pattern stored in the database 140. Although not shown, the database 140 includes basic massage patterns for performing functions, such as fingering, tap, press, and relaxation which play the role of a massage according to genre. In other words, the basic massage patterns may include a pop music massage pattern, a classical music massage pattern, a rock music massage pattern, and a Latin music massage pattern according to music genres. The basic massage patterns may include patterns, such as 2/4 time, 4/4 time, ¾ time, and 6/8 time, according to rhythm. Furthermore, the basic massage patterns may include various kinds of patterns derived from genres and rhythm. The constructions of the functions, such as fingering, tap, press, and relaxation which play the role of a massage, may be basically set differently according to the patterns and may have a fast or slow speed according to the rhythms.

In order to properly perform a massage according to music having a variable genre and rhythm (that is, one of the major characteristics of contemporary music), only the basically set patterns are insufficient. For this reason, in order to change a pattern, the pattern load unit 161 loads a basic massage pattern, having the most similar genre to the attribute of a sound source classified as a frequency component value by the music classification module 150. A pattern change unit 162 changes a construction so that any one of the functions, such as fingering, tap, press, and relaxation, is performed a lot or less according to a genre in a pattern set by default and also changes rhythm according to a played sound source, thereby generating a massage pattern associated with the played music.

For example, when a user who uses the massage apparatus operating in conjunction with music plays ‘Sonata for Arpeggione and Piano’ by F. P. Schubert, the music classification module 150 compares the inputted sound source signal for each genre based on its frequency component value and recognizes the inputted sound source signal as a classical music genre having the most similar frequency component value as the inputted sound source signal. Next, when musical instruments used in the inputted sound source signal are a piano and a cello which have the most similar frequency component as the inputted sound source signal as a result of a comparison for each musical instrument, a first movement is determined to be 4/4 time, a second movement is determined to be ¾ time, and a third movement is determined to be 2/4 time according to the frequency components of the musical instruments. The pattern load unit 161 loads a relevant classical music pattern from the massage database based on the determined attributes. The pattern change unit 162 changes the massage function of the classical music pattern, set by default, so that the massage function performs relaxation in order to avoid monotony that may occur when one kind of a basic music pattern is repeated and to provide a massage operating in conjunction with the sound source and also changes a massage pattern to be outputted by changing the speed of the massage, including 4/4 time, ¾ time, and 4/4 time not one kind of rhythm.

FIG. 4 is a detailed block diagram of the output channel change module 170 according to the present invention.

The output channel change module 170 adjusts the output of a massage pattern, changed by the massage pattern change module 160, for each pad in order to avoid the same output of all the massage pads and to provide various massages. The rhythm check unit 171 of the output channel change module 170 outputs the massage pattern, changed by the pattern change module 160, with different rhythms according to channels. Furthermore, the strength and weakness check unit 172 of the output channel change module 170 outputs the massage pattern, changed by the pattern change module 160, with different strength and weakness according to channels. The multiplexer 173 of the output channel change module 170 outputs an output signal changed by the rhythm check unit 171 and the strength and weakness check unit 172 for each channel.

In particular, the output channel change module 170 classifies and sets the output channels according to the rhythm of a sound source signal and the height of a tone so that the massage pattern is outputted to the output terminals of different massage pads according to the rhythm of the sound source signal and the height of the tone. For example, a massage pattern classified according to the rhythm of a sound source signal may be outputted to the output terminal of a first massage pad, and a massage pattern classified according to the height of a tone may be outputted to the output terminal of a second massage pad.

Furthermore, in order to solve tracking occurring when a sound source signal has a different area, the low frequency massage apparatus of the present invention may further include a frequency tuning module for differently tuning the frequency of a sound source signal according to the height of a preset tone.

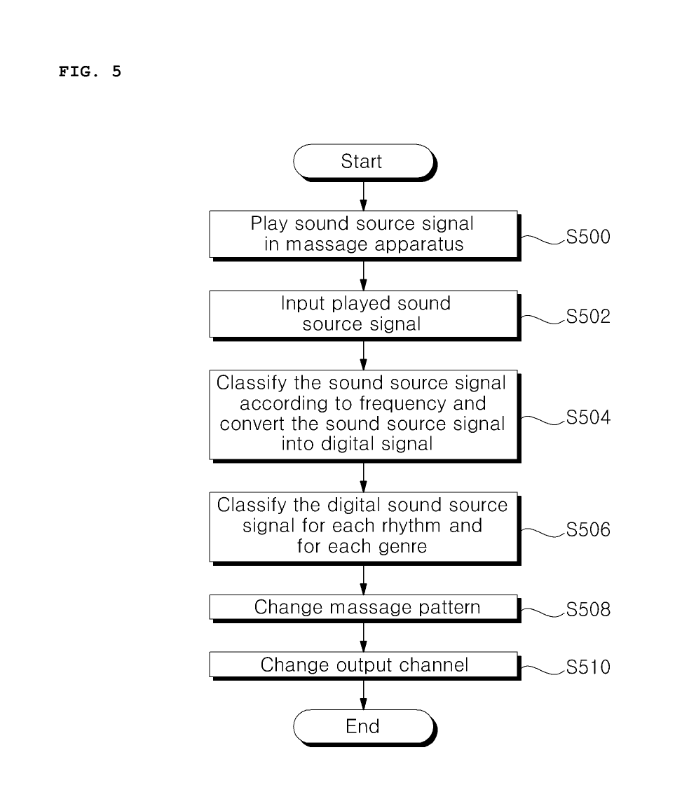

FIG. 5 is a flowchart illustrating a massage method operating in conjunction with music according to the present invention.

As shown in FIG. 5, when a user plays a sound source in the massage apparatus at step S500, the played sound source signal is inputted at step S502. The inputted sound source signal is separated according to the frequency through the frequency filter module 120 and digitally converted at step S504. The digitally converted sound source signal is compared with frequency information stored in the database 140 and classified for each genre or for each rhythm at step S506. Next, a basic massage pattern according to a genre stored in the database 140 is loaded and then changed by adjusting strength and weakness or rhythm at step S508. The changed massage pattern is changed according to a channel for each pad at step S510, and various massages are provided.

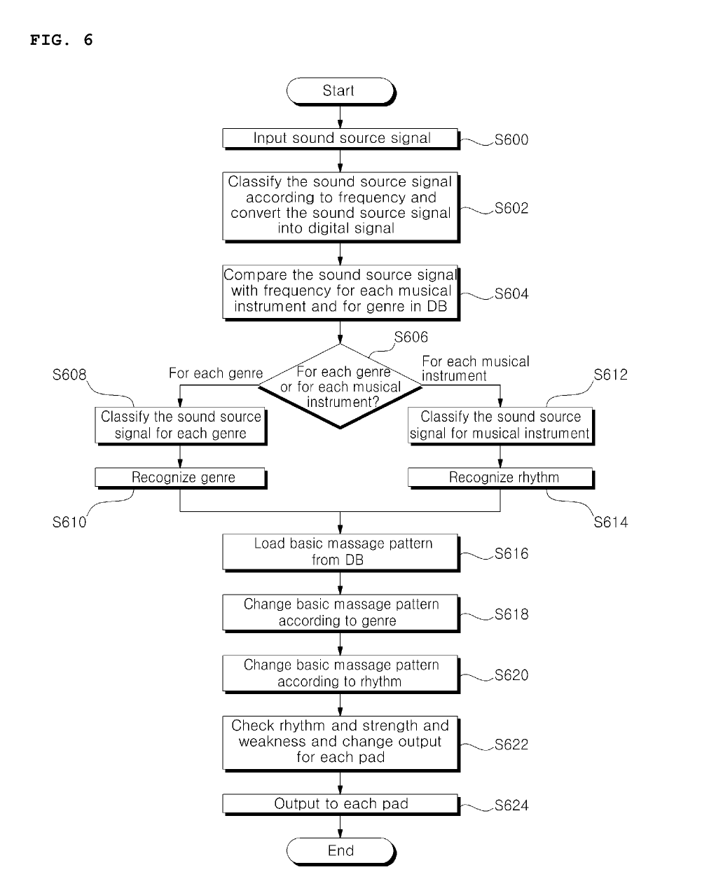

FIG. 6 is a flowchart illustrating an embodiment in which the low frequency massage apparatus operating in conjunction with music according to the present invention is used.

As shown in FIG. 6, in order to have a massage, a user sits on the low frequency stimulators of the low frequency massage apparatus and then plays a sound source in the low frequency massage apparatus operating in conjunction with music. The user may listen to the selected sound source, while having the massage, or may have only the massage according to the played sound source without listening to the sound source. The played sound source signal is inputted to the input module 110 at step S600. The inputted sound source signal is separated according to the frequency through the frequency filter module 120 and then digitally converted by the A/D converter 130 at step S602. The database 140 has stored pieces of information according to frequencies for each musical instrument and for each genre. The digitally converted sound source signal is compared with the information stored in the database 140 at step S604 and then classified for each genre and for each musical instrument at step S606.

First, in order to classify the sound source signal for each genre, a genre of the sound source signal is determined at step S610 by comparing an average value of frequency components according to a genre, stored in the database 140, and a value of frequency components obtained by the frequency filter module 120 in order to determine the most similar genre of the sound source signal at step S608. Furthermore, in order to classify the sound source signal for each musical instrument, musical instruments used to play the sound source signal are determined at step S612 by comparing an average value of frequency components according to the musical instruments, stored in the database 140, and a value of frequency components obtained by the frequency filter module 120. When the musical instruments are determined based on the frequency components, rhythm of the sound source signal is determined at step S614. For example, if a drum exists in the determined musical instruments, it is convenient to recognize the rhythm as a value of drum frequency components because the drum is chiefly responsible for the rhythm.

After the genre and the rhythm are determined, a basic music pattern of the relevant genre is loaded from the basic massage patterns, such as a pop music massage pattern, a classical music massage pattern, a rock music massage pattern, and a Latin music massage pattern according to music genres so that the functions, such as fingering, tap, press, and relaxation which play the role of a massage, can be performed at step S616. Next, the basic massage pattern according to the genre is changed with reference to the genre and rhythm for the played sound source signal classified by the music classification module 150 at step S618, and the basic massage pattern according to the rhythm is changed at step S620. For example, when music having a static and monotonous melody, such as classical music ‘the Moonlight Sonata’, is being played, the classical music pattern of the basic massage patterns may be loaded, a massage may be chiefly performed based on the fingering function, from among the massage functions of the classical music pattern, and the remaining functions, such as tap, press, and relaxation, may be additionally performed. Accordingly, the basic massage pattern of the classical music pattern set by default is changed. When the played sound source is dance music or trot having fast rhythm, the Latin music massage pattern of the basic massage patterns may be loaded, a massage may be chiefly performed based on the tap function, from among the massage functions, and the remaining functions, such as fingering, press, and relaxation, may be additionally performed. Accordingly, the basic massage pattern of the Latin music pattern set by default is changed. Next, the basic music pattern changed according to the genre becomes fast or slow according to rhythm based on rhythm information about the played sound source signal. Accordingly, the basic massage pattern according to the rhythm is changed.

A genre and rhythm have been chiefly described as an example. Climaxes corresponding to a change of the intensity of a singer's voice may be classified based on sound source signals separated according to their frequencies, and the basic music patterns of a massage may be changed based on the climaxes. In addition, the basic massage patterns may be changed based on elements constituting a sound source.

After the basic music pattern is changed based on the genre and the rhythm, output for each pad is changed in order to provide a more efficient massage at step S622. In order not to output the changed basic music pattern to the same channels of the output channel change module 170, only 4 time may be set to be outputted to an odd-numbered channel and only 8 time may be set to be outputted to an even-numbered channel according to the rhythm of the sound source signal. Likewise, only high output may be set to be outputted to the odd-numbered channel and only low output may be set to be outputted to the even-numbered channel according to the rhythm of the sound source signal, and the vice versa. Accordingly, the music pattern is outputted according to a change in the output channel for each pad through the multiplexer at step S624. In addition, in order to provide an effective massage to a user, when input is low, a lower output may be outputted according to a channel, and when input is high, a higher output may be outputted according to a channel.

In particular, the output channels are classified and set according to the rhythm of a sound source signal and the height of a tone such that a massage pattern can be classified and outputted to the output terminals of different massage pads according to the rhythm of the sound source signal and the height of the tone. For example, a massage pattern classified according to the rhythm of a sound source signal may be outputted to the output terminal of a first massage pad, and a massage pattern classified according to the height of a tone may be outputted to the output terminal of a second massage pad.

Furthermore, in order to solve tracking occurring when a sound source signal has a different area, the frequency of a sound source signal may be differently tuned according to the height of a preset tone.

As described above, the low frequency massage apparatus operating in conjunction with music and the method of operating the same according to the present invention are advantageous in that they can provide a natural and pleasant massage to a user, as if the user listens to music, because they detect a shift of the music in conjunction with the music and apply the shift to the output terminals according to the pads.

Furthermore, since the artificial low frequency massage apparatus provides a natural and pleasant massage, the circulation of the blood and fatigue relief can be increased as if a user has an actual massage.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A low frequency massage apparatus operating in conjunction with music, comprising:
a wired sound source input module for receiving a sound source signal being played;
a frequency filter module for classifying the inputted sound source signal according to frequencies;
an A/D converter module for digitally converting the sound source signal classified by the frequency filter module;
a music classification module for classifying the converted sound source signal for each musical instrument or for each genre;
a database for storing pieces of frequency information for each musical instrument, pieces of frequency information for each genre, and pieces of massage pattern information;
a massage pattern change module for loading a massage pattern, corresponding to the sound source signal classified by the music classification module, from the database and changing the massage pattern according to frequency components of the sound source signal; and
an output channel change module for setting the massage pattern, changed by the massage pattern change module, for each output channel and outputting the set massage pattern to the output terminals of massage pads.

2. The low frequency massage apparatus as claimed in claim 1, wherein the output channel change module classifies and sets the output channels according to rhythm of the sound source signal and a height of a tone and outputs the massage pattern to the output terminals of the different massage pads according to the rhythm of the sound source signal and the height of the tone.

3. The low frequency massage apparatus as claimed in claim 2, further comprising a frequency tuning module for tuning the frequency of the sound source signal according to a height of a preset tone in order to solve tracking occurring when an area of the sound source signal is different.

4. The low frequency massage apparatus as claimed in claim 1, wherein the music classification module comprises:
a load unit for loading a value of frequency components corresponding to the frequency information for each musical instrument or the frequency information for each genre;
a frequency comparison unit for comparing the value of the frequency components, loaded by the load unit, and a value of the frequency components of the sound source signal; and
an attribute determination unit for classifying rhythm and a genre of the sound source based on the value obtained by the frequency comparison unit.

5. The low frequency massage apparatus as claimed in claim 1, wherein the massage pattern change module comprises:
a pattern load unit for loading a massage pattern of a relevant genre from the database based on a genre of the sound source signal classified by the music classification module; and
a pattern change unit for changing the loaded massage pattern of the genre based on a value of the frequency components of the sound source signal.

6. The low frequency massage apparatus as claimed in claim 1, wherein the output channel change module comprises:
a rhythm check unit for changing rhythm of each of the channels from which the massage pattern changed by the massage pattern change module is outputted;
a strength and weakness check unit for changing a strength and weakness of each channel from which the massage pattern changed by the massage pattern change module is outputted; and
a multiplexer for sending a changed signal to each channel from which the massage pattern changed by the rhythm check unit and the strength and weakness check unit is outputted.

7. A low frequency massage apparatus operating in conjunction with music, comprising:
a wireless communication module for receiving a sound source signal, being played, from sound source play means through wireless transmission in order to facilitate connection to the sound source play means;
a frequency filter module for classifying the inputted sound source signal according to frequencies;
an A/D converter module for digitally converting the sound source signal classified by the frequency filter module;
a music classification module for classifying the converted sound source signal for each musical instrument or for each genre;
a database for storing pieces of frequency information for each musical instrument, pieces of frequency information for each genre, and pieces of massage pattern information;
a massage pattern change module for loading a massage pattern, corresponding to the sound source signal classified by the music classification module, from the database and changing the massage pattern according to frequency components of the sound source signal; and
an output channel change module for setting the massage pattern, changed by the massage pattern change module, for each output channel and outputting the set massage pattern to the output terminals of massage pads.

8. The low frequency massage apparatus as claimed in claim 7, wherein the output channel change module classifies and sets the output channels according to rhythm of the sound source signal and a height of a tone and outputs the massage pattern to the output terminals of the different massage pads according to the rhythm of the sound source signal and the height of the tone.

9. The low frequency massage apparatus as claimed in claim 8, further comprising a frequency tuning module for tuning the frequency of the sound source signal according to a height of a preset tone in order to solve tracking occurring when an area of the sound source signal is different.

10. The low frequency massage apparatus as claimed in claim 7, wherein the music classification module comprises:
a load unit for loading a value of frequency components, corresponding to the frequency information for each musical instrument or the frequency information for each genre;
a frequency comparison unit for comparing the value of the frequency components, loaded by the load unit, and a value of the frequency components of the sound source signal; and
an attribute determination unit for classifying rhythm and a genre of the sound source based on the value obtained by the frequency comparison unit.

11. The low frequency massage apparatus as claimed in claim 7, wherein the massage pattern change module comprises:
a pattern load unit for loading a massage pattern of a relevant genre from the database based on a genre of the sound source signal classified by the music classification module; and
a pattern change unit for changing the loaded massage pattern of the genre based on a value of the frequency components of the sound source signal.

12. The low frequency massage apparatus as claimed in claim 7, wherein the output channel change module comprises:
a rhythm check unit for changing rhythm of each of the channels from which the massage pattern changed by the massage pattern change module is outputted;
a strength and weakness check unit for changing a strength and weakness of each channel from which the massage pattern changed by the massage pattern change module is outputted; and
a multiplexer for sending a changed signal to each channel from which the massage pattern changed by the rhythm check unit and the strength and weakness check unit is outputted.

13. A low frequency massage method operating in conjunction with music, the method comprising the steps of:
playing a sound source signal in the massage apparatus;
inputting the played sound source signal;
converting the inputted sound source signal into a digital signal through a frequency filter;
classifying the sound source signal, converted into the digital signal, for each rhythm and for each genre;
changing a massage pattern according to an input signal of the classified sound source signal based on a pattern stored in a database; and
changing the changed massage pattern for each pad and outputting the changed massage pattern.
